(19) United States
(12) Patent Application Publication
(10) Pub. No.: US 2013/0235170 A1
(43) Pub. Date: Sep. 12, 2013

(54) Electronic Apparatus and Method Utilized in Stereo Glasses

(71) Applicant: MSTAR SEMICONDUCTOR, INC., Hsinchu County (TW)

(72) Inventors: Shih-Yuan Huang, Hsinchu County (TW); Yen-Lin Lee, Hsinchu County (TW); Chih-Cheng Ku, Hsinchu County (TW); Shan-Cheng Sun, Hsinchu County (TW)

(73) Assignee: MSTAR SEMICONDUCTOR, INC., Hsinchu County (TW)

(21) Appl. No.: 13/739,146

(22) Filed: Jan. 11, 2013

(30) Foreign Application Priority Data
Mar. 8, 2012 (TW) 101107839

(51) Int. Cl. H04N 13/04; G02B 27/22

(52) U.S. Cl. CPC H04N 13/04; G02B 27/2264
USPC 348/55; 359/464

(57) ABSTRACT

An electronic apparatus utilized in stereo glasses is provided. The electronic apparatus includes a first receiver, a second receiver, and a synchronization controller. The first receiver receives a first synchronization signal, and the second receiver receives a second synchronization signal. The transmission mechanism of the second synchronization signal is different from that of the first synchronization signal. The synchronization controller coupled to the first and the second receivers synchronizes left-eye/right-eye shutter glasses of the stereo glasses with a corresponding left-eye/right-eye frame of a stereo image according to at least one of the first and second synchronization signals.

### CROSS REFERENCE TO RELATED PATENT APPLICATION

This patent application is based on Taiwan, R.O.C. patent application No. 101107839, filed Mar. 8, 2012.

### FIELD OF THE INVENTION

The present invention relates to a synchronization mechanism for stereo glasses, and more particularly, to an electronic apparatus and method applied to a pair of stereo glasses for synchronizing corresponding frames with shutter glasses.

### BACKGROUND OF THE INVENTION

A current mainstream three-dimension (3D) stereo display apparatus applies an interlacing display mode to separate a left-eye image and a right-eye image, i.e., the left-eye image and the right-eye image are displayed in an interfacing fashion, so that a user can observe a 3D film via a pair of shutter stereo glasses. The pair of shutter stereo glasses needs to continuously receive synchronization signals transmitted from a display apparatus or a transmission apparatus externally coupled to the display apparatus, so as to synchronize an open/closed status of a left-eye/right-eye shutter glass with timing of left-eye/right-eye frames to be displayed by the display apparatus via the synchronization signal. Once the stereo glasses cannot successfully receive the synchronization signal since the synchronization signal is stopped or interfered due to the transmission mechanism characteristics, the open/closed status of the left-eye/right-eye shutter glass of the pair of shutter glasses cannot be synchronized with timing of the left-eye/right-eye frames to be displayed by the display apparatus, and significant crosstalk is created in the frame which is observed by the user, deteriorating image quality or even causing a failure of displaying a stereo image.

### SUMMARY OF THE INVENTION

One object of the present invention is to provide an electronic apparatus and a method applied to stereo glasses to solve the foregoing problem.

According to an embodiment of the present invention, an electronic apparatus comprises a first receiver, a second receiver, and a synchronization controller. The first receiver receives a first synchronization signal, and the second receiver receives a second synchronization signal. A transmission mechanism of the second synchronization signal is different from that of the first synchronization signal. The synchronization controller coupled to the first receiver and the second receiver synchronizes a left-eye/right-eye shutter glass of a pair of stereo glasses with a corresponding left-eye/right-eye frame of a stereo image according to at least one of the first and second synchronization signals.

According to another embodiment of the present invention, a method comprises receiving a first synchronization signal; receiving a second synchronization signal having a transmission mechanism different from that of the first synchronization signal; and synchronizing a left-eye/right-eye shutter glass of a pair of stereo glasses with a corresponding left-eye/right-eye frame of a stereo image according to at least one of the first and second synchronization signals.

According to yet another embodiment, a method applied to a pair of stereo glasses comprising a first receiver and a second receiver is provided. The method comprises determining whether the first receiver receives a first synchronization signal; synchronizing a left-eye/right-eye shutter glass of the pair of stereo glasses with a corresponding left-eye/right-eye frame of a stereo image according to the first synchronization signal when the first receiver receives the first synchronization signal; and activating the second receiver to receive a second synchronization signal and synchronizing the left-eye/right-eye shutter glass of the stereo glasses with the corresponding left-eye/right-eye frame of the stereo image according to the second synchronization signal when the first receiver does not receive the first synchronization signal.

In addition, according to the present invention, different transmission mechanisms are applied to achieve a cooperative stereo glasses synchronization control mechanism. For example, the first receiver is an infrared receiver, and the second receiver is a frequency-modulation (FM) receiver. Except for the pair of stereo glasses, an FM transmitter is externally coupled to the display apparatus. Since the FM transmission mechanism can make up for disadvantages of infrared transmission mechanism due to the advantage that the FM transmission has a signal receiving range, a data transmission amount and transmission characteristics different from those of the infrared transmission mechanism, the pair of stereo glasses is capable of receiving a synchronization signal transmitted via the FM transmission mechanism while failing to receive the synchronization signal transmitted via the infrared transmission mechanism, so as to reduce power consumption as well as maintaining synchronization of the left-eye/right-eye shutter glass of the pair of stereo glasses and the corresponding left-eye/right-eye frame of the stereo image. Therefore, according to the present invention, not only the synchronization signal transmitted via the infrared transmission mechanism but also the synchronization signal transmitted via the FM transmission mechanism can be received at the end of the pair of stereo glasses, so that the disadvantage of single transmission mechanism is overcame through the cooperative stereo glasses synchronization control mechanism based on different transmission mechanisms.

### BRIEF DESCRIPTION OF THE DRAWINGS

The advantages and spirit related to the present invention can be further understood via the following detailed description and drawings.

FIG. 1 is a schematic diagram of an electronic apparatus applied to a pair of stereo glasses in accordance with an embodiment of the present invention.

FIG. 2 is a schematic diagram of detailed circuits of a synchronization controller, a first receiver and a second receiver of the electronic apparatus disclosed in FIG. 1 in accordance with an embodiment of the present invention.

FIG. 3 is a schematic diagram of a first synchronization signal S1 disclosed in FIG. 1 in accordance with an embodiment of the present invention.

FIG. 4 is a schematic diagram of switch statuses of receiving modes of the electronic apparatus disclosed in FIG. 1 in accordance with an embodiment of the present invention.

### DETAILED DESCRIPTION OF THE PREFERRED EMBODIMENT

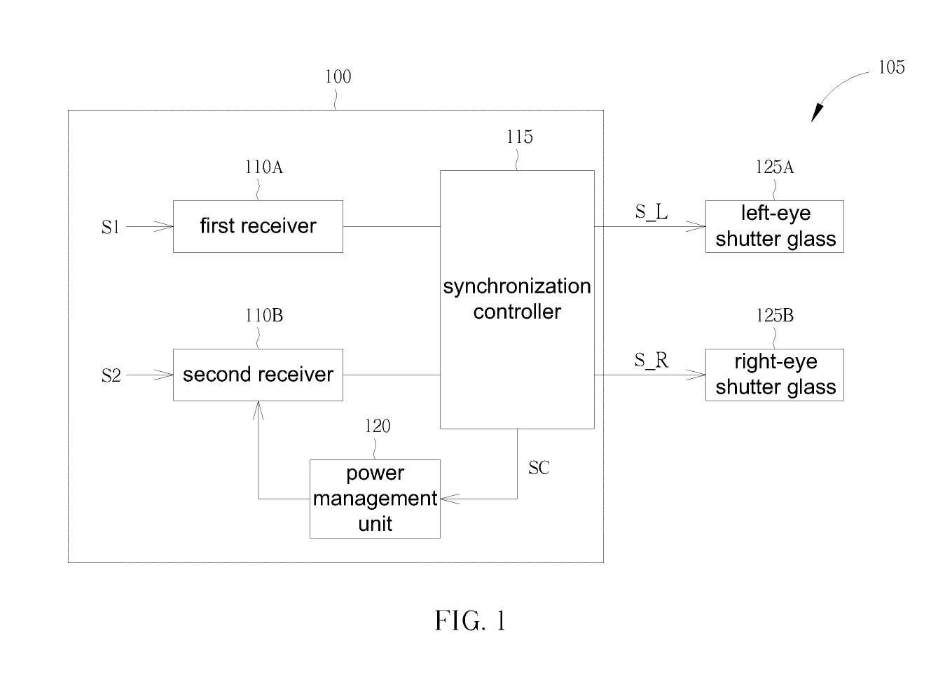

Refer to FIG. 1 showing an electronic apparatus 100 applied to a pair of stereo glasses 105 in accordance with an embodiment of the present invention. The electronic apparatus 100 comprises a first receiver 110A, a second receiver 110B, a synchronization controller 115, and a power management unit 120. The first receiver 110A receives a first synchronization signal S1, and the second receiver 110B receives a second synchronization signal S2 having a transmission mechanism different from that of the first synchronization signal S1. The synchronization controller 115 coupled to the first receiver 110A and the second receiver 110B synchronizes a left-eye shutter glass 125A or a right-eye shutter glass 125B of the pair of stereo glasses 105 with a corresponding left-eye or right-eye frame of a stereo image according to at least one of the first synchronization signal and the second synchronization signal. The power management unit 120 coupled to the second receiver 110B and the synchronization controller 115 controls a power supply status of the second receiver 110B according to a switch control signal SC outputted by the synchronization controller 115. According to the present invention, the first synchronization signal S1 adopts a directional transmission mechanism, and the second synchronization signal S2 adopts a non-directional transmission mechanism. For example, the first synchronization signal S1 is an infrared signal, and the second synchronization signal S2 is an FM signal or a Bluetooth signal. That is to say, the pair of stereo glasses 105 has a capability of receiving two paths of synchronization signals that are transmitted via two different transmission mechanisms. The two paths of synchronization signals are received and modulated to synchronize the left-eye shutter glass 125A or the right-eye shutter glass 125B of the pair of stereo glasses 105 with the corresponding left-eye or right-eye frame of the stereo image. Therefore, once a shutter glass is synchronized with a frame, the synchronization controller 115 performs synchronization according to only one of the first synchronization S1 and the second synchronization S2. According to the present invention, in order to maintain high display quality of the stereo image, the first receiver 110A and the second receiver 110B of the electronic apparatus 100 receives different synchronization signals respectively, so that the electronic apparatus 100 is still capable of receiving another synchronization signal to perform synchronization of an open/closed status of the shutter glass and the corresponding frame when the electronic apparatus fails to receive a certain synchronization signal (e.g., possibly being stopped or interfered). Therefore, the synchronization controller 115 continues to output proper control signals to control the open/closed status of the left-eye shutter glass 125A and the right-eye shutter glass 125B by dynamically referring to the first synchronization signal S1 or the second synchronization signal S2, so as to accurately synchronize timing of the left-eye/right-eye shutter glass 125A/125B and the left-eye/right-eye frame of the pair of stereo image. Accordingly, the left-eye/right-eye shutter glass 125A/125B is accurately opened or closed during each timing sequence due to the abovementioned synchronization, so that human eyes can see appropriate left-eye/right-eye frames to observe an appropriate stereo image during each timing sequence without getting any uncomfortable feelings.

In addition, since the pair of stereo glasses 105 is a portable apparatus, a power supply unit is adopted to provide power supply to internal circuits. Therefore, in order to achieve an object of reducing power consumption in the condition that two receivers are applied to the pair of stereo glasses, the first receiver 110A and the second receiver 110B even adopts different transmission mechanisms having different power consumptions. For example, the first receiver 110A consumes less power, and the second receiver 110B consumes relatively more power. When the first synchronization signal S1 and the second synchronization S2 are received and detected, only the first receiver 110A is activated to reduce power consumption, i.e., the power supply unit of the pair of stereo glass 105 only provides a power supply to the first receiver 110A but not the second receiver 110B. When the first receiver 110A cannot receive the first synchronization signal S1 that is stopped or interfered, the second receiver 110B is activated, and the power supply unit starts to provide power supply to the second receiver 110B, such that the second receiver 110B receives the second synchronization signal S2 while the power supply of the first receiver 110A is cut off. As mentioned above, the first receiver 110A is an infrared receiver and the second receiver 110B is an FM receiver or a Bluetooth receiver, and infrared transmission mechanism is directional and the FM or Bluetooth transmission mechanism is non-directional. Therefore, when the first receiver 110A cannot successfully receive the first synchronization signal S1 for the reason that infrared lines is stopped or interfered (e.g., when a person passes by), the second receiver 110B of the electronic apparatus 100 is activated or enabled in time to receive the second synchronization signal S2, such that the synchronization controller 115 is able to instantly synchronize timing of the open/closed status of the shutter glasses and frames thus guaranteeing accurate stereo image preservation of human eyes without getting any uncomfortable feelings.

The power management unit 120 is in charge of activating or deactivating the second receiver 110B. When the first receiver 110A cannot successfully receive or detect the first synchronization signal S1 during a predetermined time period, meaning that the first synchronization signal S1 is stopped or interfered, the first receiver 110A informs the synchronization controller 115 after the predetermined time period. Upon being informed by the first receiver 110A, the synchronization controller 115 outputs a switch control signal to the power management unit 120 so as to maintain synchronizing the open/closed statuses of the shutter glasses with the frames. When the switch controls signal is received, the power management unit 120 enables and activates the second receiver 110B to receive the second synchronization signal S2. Since the transmission mechanism of the second synchronization signal S2 is non-directional, the second synchronization signal S2 is neither stopped nor interfered, such that the second receiver 110B receives the second synchronization signal S2 and the synchronization controller 115 can still synchronize the open/closed statues of the shutter glasses with the frames according to the second synchronization signal S2 received by the second receiver 110B even if the first receiver 110A cannot successfully receive the first synchronization signal S1. In addition, when the first receiver 110A successfully receives or detects the first synchronization signal S1, the first receiver 110A informs the synchronization controller 115, such that the synchronization controller 115 outputs the switch control signal to the power management unit 120 to cut off the power supply of the second receiver 110B so as to achieve the object of reducing power consumption. When the switch control signal is received, the power management unit 120 cuts off the power supply of the second receiver 110B to stop receiving the second synchronization signal S2, thus reducing power consumption. For example, the power management unit 120 cuts off the power supply of the entire second receiver 110B based on the object of reducing power consumption; however, when other design objects are taken into consideration (e.g., an object of rapidly activating the second receiver 110B for the next time), the power management unit 120 decreases the power supply of the second receiver 110B instead of cutting off the power supply of the entire second receiver 110B. For the power supply unit of the pair of stereo glasses 105, the object of reducing power consumption is also achieved regardless of whether the power supply of the entire or a part of the second receiver 110B is cut off. In another embodiment, the synchronization controller 115 detects whether the first receiver 110A receives the first synchronization signal S1, i.e., the synchronization controller 115 continuously detects whether the first receiver 110A receives the first synchronization signal S1. When the first receiver 110A does not receive the first synchronization signal S1 during a predetermined time period, the synchronization controller 115 transmits a switch control signal to the power management unit 120 to activate or enable the second receiver 110B. When the first receiver 110A again receives the first synchronization signal S1, the synchronization controller 115 transmits a switch control signal to the power management unit 120 to turn down the second receiver 110B. In addition, the foregoing predetermined time period is determined according to an activating speed of the second receiver 110B, and open/closed time interval of the pair of stereo glasses 105 or other experimental data. For example, when an experimental data indicates that no synchronization signal is detected during a time period T1, synchronization is failed, so that a predetermined time period T2 is designed as being smaller than the time period T1, i.e., when the first synchronization signal S1 is yet not received after the predetermined time period T2, it means that there is a high probability of synchronization failure. At this point, the second receiver 110B is activated to receive the second synchronization signal S2 and the synchronization controller 115 changes to perform synchronization according to the received second synchronization signal S2, i.e., synchronization is performed in advance according to the second synchronization signal S2 when the synchronization failure is not yet confirmed. Accordingly, continuous synchronization of the open/closed status of the pair of stereo glasses 105 and the frames is maintained, and thus guaranteeing high quality of observation.

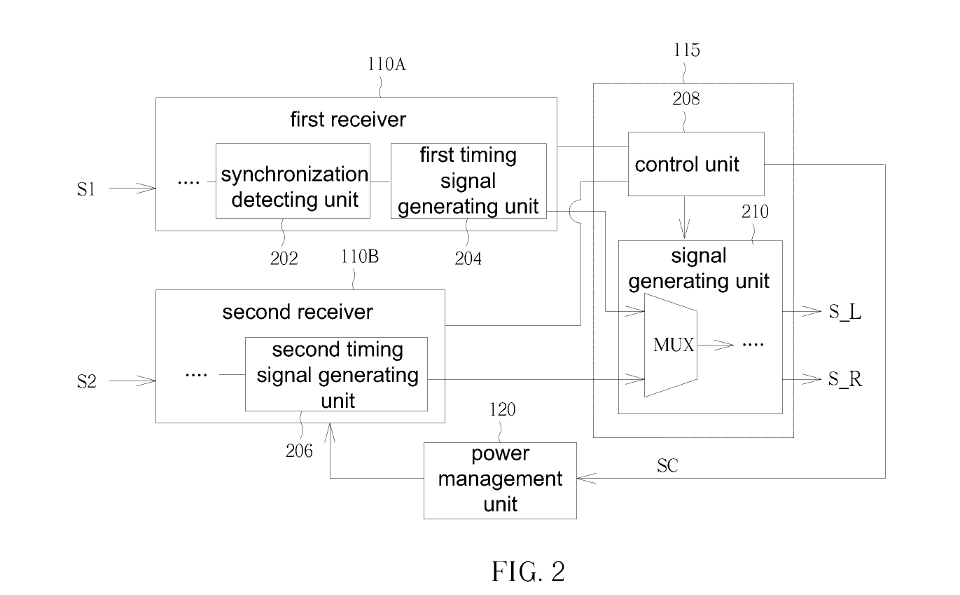

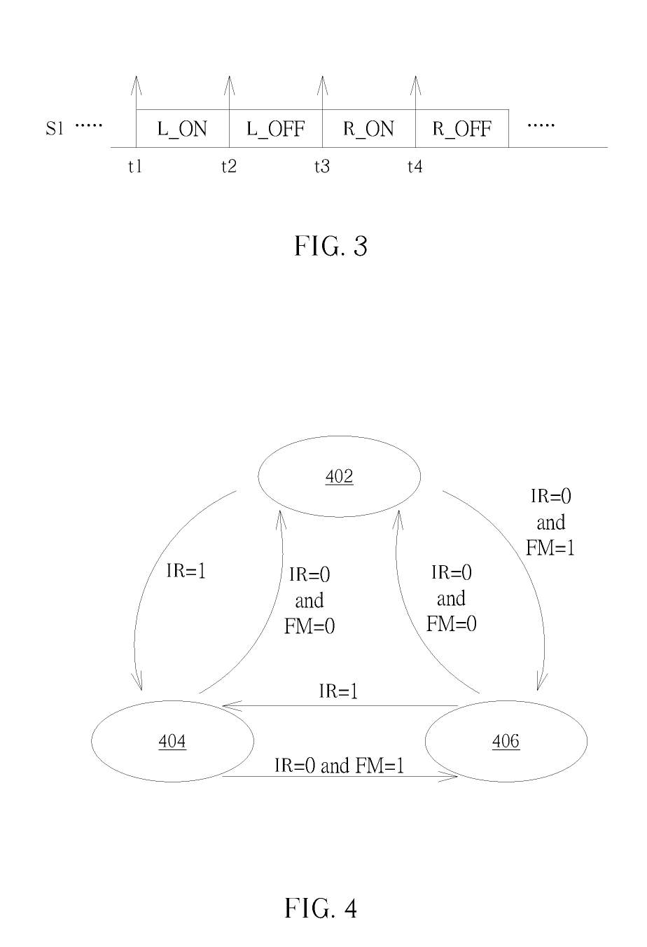

Referring to FIG. 2, a schematic diagram of detailed circuits of the synchronization controller 115, the first receiver 110A, and the second receiver 110B of the electronic apparatus 100 disclosed in FIG. 1 is shown in accordance with an embodiment of the present invention. For example, the first receiver 110A (e.g., an infrared receiver) comprises a synchronization detecting unit 202 and a first timing signal generating unit 204. The second receiver 110B (e.g., an FM receiver) comprises a second timing signal generating unit 206, and the synchronization controller 115 comprises a control unit 208 and a signal generating unit 210 that comprises a multiplexer MUX. With respect to the first synchronization signal S1 (i.e., an infrared signal) reception, since a transmission amount of infrared modulation transmission is small, an infrared data from the display apparatus or an external transmitter cannot directly transmit an image (e.g., a frame) playing frequency of the display apparatus or corresponding open/closed adjustment of the pair of stereo glasses 105. Therefore, the synchronization detecting unit 202 detects the first synchronization signal S1 and generates a result representing the image playing frequency and the corresponding open/closed adjustment of the pair of stereo glasses 105. Referring to FIG. 3, a schematic diagram of the first synchronization signal S1 in FIG. 1 in accordance with an embodiment of the present invention is shown. The first synchronization signal S1 comprises commands L_ON, L_OFF, R_ON, and R_OFF respectively representing corresponding switch timing sequences of the open/closed statuses of the left-eye shutter glass 125A and the right-eye shutter glass 125B of the pair of stereo glasses 105. For example, the command L_ON indicates that the left-eye shutter glass 125A is opened at a time point t1, the command L_OFF indicates that the left-eye shutter glass 125A is closed at a time point t2, the command R_ON indicates that the right-eye shutter glass 125B is opened at a time point t3, and the command R_OFF indicates that the right-eye shutter glass 125B is closed at a time point t4. The synchronization detecting unit 202 detects/counts the number of commands contained in the first synchronization signal S1 during a predetermined time period to calculate respective average open time, average closed time, average cycle of the open command, and the average cycle of the closed command of the left-eye shutter glass 125A and the right-eye shutter glass 125B. The average open/closed time and the average cycle of the open/closed command represent result information of the image playing frequency and corresponding shutter open/closed adjustment of the pair of stereo glasses 105. The result information is outputted from the synchronization detecting unit 202 to the first timing signal generating unit 204. The first timing signal generating unit 204 generates a timing signal for practical synchronization according to the result information, and outputs the timing signal to the multiplexer MUX of the signal generating unit 210 of the synchronization controller 115. Therefore, once the first receiver 110A fails to receive the first synchronization signal S1 that is stopped or interfered, the multiplexer MUX does not receive the foregoing timing signal.

With respect to FM signal reception, since a data transmission amount of FM modulation transmission is relatively large, an FM data from the display apparatus or an external transmitter can directly transmit an image (e.g., a frame) playing frequency of the display apparatus and corresponding shutter open/closed adjustment of the pair of stereo glasses 105. Therefore, a synchronization detecting unit is no longer needed for detecting the second synchronization signal S2 to generate result information representing the image playing frequency and the corresponding shutter open/closed adjustment of the pair of stereo glasses 105. The second timing signal generating unit 206 directly generates the timing signal for practical synchronization according to the image playing frequency and the corresponding shutter open/closed adjustment of the pair of stereo glasses 105 contained in the second synchronization signal S2, and outputs the timing signal to the multiplexer MUX of the signal generating unit 210 of the synchronization controller 115.

The control unit 208 of the synchronization controller 115 detects operation status of the first receiver 110A (or a signal from any circuit component of the first receiver 110A) to determine whether the first synchronization signal S1 is stopped or interfered, and appropriately controls switch of the multiplexer MUX. For example, the multiplexer MUX selects a timing signal generated from the first timing signal generating unit 204 as an output to generate open/closed adjustment signals S_L and S_R of the left-eye/right-eye shutter glass 125A/125B of the pair of stereo glasses 105. In other embodiment, the control unit 208 counts a time length of the interval which the timing signal generated by the first timing signal generating unit 204 does not be received, and determines that the first synchronization signal S1 cannot be currently successfully received once the time length beyond the predetermined time period T2. At this point, in order to maintain continuous synchronization, the control unit 208 transmits a switch control signal SC to the power management unit 120 to activate power supply of the second receiver 110B. Therefore, the second timing signal generating unit 206 is activated and generates the timing signal for synchronization according to the foregoing result information contained in the second synchronization signal S2. At this point, the control unit 208 transmits a control signal to the multiplexer MUX, which performs switching to select the timing signal generated by the second timing signal generating unit 206 as an output, so as to generate subsequent open/closed adjustment signals S_L and S_R for controlling the left-eye shutter glass 125A and the right-eye shutter glass 125B of the pair of stereo glasses 105. In other words, the control unit 208 determines whether to change from an infrared receiving mode of the first receiver 110A to an FM receiving mode of the second receiver 110B. In addition, the control unit 208 also determines whether to switch from the FM receiving mode of the second receiver 110B to the infrared receiving mode of the first receiver 110A. For example, when the timing signal generated by the first timing signal generating unit 204 is detected again, the control unit 208 determines that the first synchronization signal S1 is currently successfully received, and transmits the switch control signal SC to the power management unit 120 to cut off the power supply of the second receiver 110B so as to achieve the object of reducing power consumption. Therefore, the second timing signal generating unit 206 is closed, and the control unit 208 also transmits a control signal to the multiplexer MUX to switch and select the timing signal generated by the first timing signal generating unit 204 as an output, so as to generate the subsequent open/closed adjustment signal S_L and S_R of the left-eye shutter glass 125A and the right-eye shutter glass 125B of the pair of stereo glasses 105. It is to be noted that, since power consumption of the second timing signal generating unit 206 is limited, when the power management unit 120 selects to reduce the power supply of the second receiver 110B, only power supplies of other circuit components of the second receiver 110B are cut off while the power supply of the second timing signal generating unit 206 is still remained. In other words, the power management unit 120 cuts off power supply to a part of circuit components of the second receiver 110B to achieve the object of reducing power consumption.

In other embodiment, in order to achieve the object of simplifying operation design as well as reducing power consumption, the power management unit 120 provides the power supply of the second receiver 110B according to the switch control signal SC outputted from the synchronization controller 115, so as to periodically or intermittently activate the second receiver 110B, i.e., activation or deactivation operations of the second receiver 110B has no relation with the result of whether the first synchronization signal S1 is successfully received. The second receiver 110B is designed as being periodically activated to receive and modulate the second synchronization signal S2. Accordingly, since the synchronization controller 115 periodically receives the second synchronization signal S2 that is received and outputted by the second receiver 110B, the synchronization controller 115 selects to perform synchronization of the open/closed status of the shutter glasses and frames according to the second synchronization signal S2 once the first synchronization signal S1 is stopped or interfered when the second receiver 110B is activated. Therefore, a possibility of continuous synchronization of the open/closed status of the shutter glasses and the frames is increased. In addition, in an embodiment, the power supply of the second receiver 110B is periodically turned on or cut off, and the power supply of the first receiver 110A remains being turned on. However, in another embodiment, in order to reduce power consumption, when the power supply of the second receiver 110B is turned on, the power supply of the first receiver 110A is cut off; and when the power supply of the second receiver 110B is cut off, the power supply of the first receiver 110A is turned on.

It is to be noted that, the first receiver 110A is an infrared receiver, and the second receiver 110B is an FM receiver or a Bluetooth receiver in the foregoing embodiments for illustration purposes. Under the premise of not departing from the spirit of the present invention, operations of the first receiver 110A (e.g., demodulation of the first synchronization signal S1) only need to be different from those of the second receiver 110B (e.g., demodulation of the second synchronization signal S2), so that the synchronization controller 115 can still perform synchronization of the open/closed status of the shutter glasses and the frames according to another synchronization signal (e.g., the synchronization signal S2) when the synchronization controller 115 cannot refer to one synchronization signal (e.g., the synchronization signal S1). Therefore, the first receiver 110A and the second receiver 110B are not limited to the infrared receiver, the FM receiver or the Bluetooth receiver, and other types of wireless receiver are also applied to the present invention. In addition, the foregoing first synchronization signal S1 and the second synchronization signal S2 are transmitted from a display apparatus having a stereo image display function or a wireless signal transmitter that is externally coupled to the display apparatus; however, it shall be construed as limiting the present invention.

For reader convenience, referring to FIG. 4, a schematic diagram of switch statuses of receiving modes of the electronic apparatus 100 disclosed in FIG. 1 in accordance with an embodiment of the present invention is shown. A status 402 represents that the first receiver 110A and the second receiver 110B of the electronic apparatus 100 cannot receive the first synchronization signal S1 and the second synchronization signal S2, or the display apparatus or a transmitter externally coupled to the display apparatus does not transmit any synchronization signal (i.e., an image displayed by the display apparatus is not a stereo image). A status 404 represents that the electronic apparatus 100 in an infrared signal receiving mode of the first receiver 110A can successfully receive the first synchronization signal S1 and cuts off the power supply of the second receiver 110B. A status 406 represents that the electronic apparatus 100 in an FM signal receiving mode of the second receiver 110B cannot receive the first synchronization signal S1, but the electronic apparatus 100 can successfully receive the second synchronization signal S2. Therefore, the electronic apparatus 100 is designed as being in the infrared signal receiving mode of the first receiver 110A (i.e., status 404) in advance. Once the pair of stereo glasses 105 is activated, when the first synchronization signal S1 and the second synchronization signal S2 cannot be successfully received or no synchronization signal is detected (‘IR=0 and FM=0’), the electronic apparatus 100 changes from the status 404 to the status 402. When the first synchronization signal is not received and the second synchronization signal S2 is successfully received (‘IR=0 and FM=1’), the electronic apparatus 100 changes from the status 404 to the status 406. When the electronic apparatus 100 is in the status 402, in the event that the first synchronization signal S1 is successfully received (‘IR=1’), the electronic apparatus 100 changes from the status 402 to the status 404; and in the event that the first synchronization signal S1 is not received and the second synchronization signal S2 is successfully received (‘IR=0 and FM=1’), the electronic apparatus 100 changes from the status 402 to the status 406. In addition, when the electronic apparatus 100 is in the status 406, in the event that the first synchronization signal S1 and the second synchronization signal S2 cannot be successfully received or no synchronization signal is detected (‘IR=0 and FM=0’), the electronic apparatus 100 changes from the status 406 to the status 402; and in the event that the first synchronization signal S1 is successfully received (‘IR=1’), the electronic apparatus 100 changes from the status 406 to the status 404.

While the invention has been described in terms of what is presently considered to be the most practical and preferred embodiments, it is to be understood that the invention needs not to be limited to the above embodiments. On the contrary, it is intended to cover various modifications and similar arrangements included within the spirit and scope of the appended claims which are to be accorded with the broadest interpretation so as to encompass all such modifications and similar structures.

What is claimed is:

1. An electronic apparatus applied to a pair of stereo glasses including a left-eye shutter glass and a right-eye shutter glass, comprising:
a first receiver, for receiving a first synchronization signal having a first transmission mechanism;
a second receiver, for receiving a second synchronization signal having a second transmission mechanism, wherein said second transmission mechanism is different from said first transmission mechanism; and
a synchronization controller, coupled to the first receiver and the second receiver, for synchronizing said left-eye shutter glass and said right-eye shutter glass with a corresponding left-eye/right-eye frame of a stereo image according to at least one of the first synchronization signal and the second synchronization signal.

2. The electronic apparatus as claimed in claim 1, wherein said synchronization controller dynamically refers to said first synchronization signal to synchronize said left-eye shutter glass and said right-eye shutter glass with said corresponding left-eye/right-eye frame of said stereo image when said second synchronization signal is not available, or said synchronization controller dynamically refers to said second synchronization signal to synchronize said left-eye shutter glass and said right-eye shutter glass with said corresponding left-eye/right-eye frame of said stereo image when said first synchronization signal is not available

3. The electronic apparatus as claimed in claim 2, further comprising:
a power management unit, coupled to said second receiver and said synchronization controller, for controlling a power supply of said second receiver according to a switch control signal outputted by said synchronization controller.

4. The electronic apparatus as claimed in claim 3, wherein said synchronization controller outputs said switch control signal to said power management unit when said first receiver does not receive said first synchronization signal during a predetermined time period, so that said power management unit enables said second receiver.

5. The electronic apparatus as claimed in claim 4, wherein said synchronization controller outputs said switch control signal to said power management unit when said first receiver receives said first synchronization signal, so that said power management unit decreases said power supply for said second receiver.

6. The electronic apparatus as claimed in claim 5, wherein said second receiver has a higher power consumption than said first receiver.

7. The electronic apparatus as claimed in claim 3, wherein said power management unit provides said power supply to intermittently activate said second receiver according to said switch control signal.

8. The electronic apparatus as claimed in claim 1, wherein said first transmission mechanism is a directional transmission mechanism, and said second transmission mechanism is a non-directional transmission mechanism.

9. The electronic apparatus as claimed in claim 8, wherein said first transmission mechanism is an infrared transmission mechanism, and said second transmission mechanism is a frequency-modulation (FM) transmission mechanism or a Bluetooth transmission mechanism.

10. The electronic apparatus as claimed in claim 1, wherein the first synchronization signal and the second synchronization signal are transmitted from a display apparatus having a stereo image display function or a wireless signal transmitter externally coupled to the display apparatus.

11. A method applied to a pair of stereo glasses including a left-eye shutter glass and a right-eye shutter glass, comprising:
receiving a first synchronization signal having a first transmission mechanism;
receiving a second synchronization signal having a second transmission mechanism, wherein said first transmission mechanism is different from said second transmission mechanism; and
synchronizing said left-eye shutter glass and said right-eye shutter glass with a corresponding left-eye/right-eye frame of a stereo image according to at least one of the first synchronization signal and the second synchronization signal.

12. The method as claimed in claim 11, wherein the step of synchronizing said left-eye shutter glass and said right-eye shutter glass with said corresponding left-eye/right-eye frame of said stereo image comprises:
dynamically referring to said first synchronization signal to synchronize said left-eye shutter glass and said right-eye shutter glass with said corresponding left-eye/right-eye frame of said stereo image when said second synchronization signal is not available, or dynamically referring to said second synchronization signal to synchronize said left-eye shutter glass and said right-eye shutter glass with said corresponding left-eye/right-eye frame of said stereo image when said first synchronization signal is not available

13. The method as claimed in claim 11, wherein said first transmission mechanism is a directional transmission mechanism, and said second transmission mechanism is a non-directional transmission mechanism.

14. The method as claimed in claim 11, wherein said first transmission mechanism is an infrared transmission mechanism, and said second transmission mechanism is an FM transmission mechanism or a Bluetooth transmission mechanism.

15. A method applied to a pair of stereo glasses that comprises a first receiver, a second receiver, a left-eye shutter glass, and a right-eye shutter glass, the method comprising:
determining whether said first receiver receives a first synchronization signal;
synchronizing said left-eye shutter glass and said right-eye shutter glass with a corresponding left-eye/right-eye frame of a stereo image according to said first synchronization signal when the first receiver receives said first synchronization signal; and
activating said second receiver to receive a second synchronization signal and synchronizing said left-eye shutter glass and said right-eye shutter glass with said corresponding left-eye/right-eye frame of said stereo image according to said second synchronization signal when said first receiver does not receive said first synchronization signal.

16. The method as claimed in claim 15, wherein said first synchronization signal is based on a first transmission mechanism, said second synchronization signal is based on a second transmission mechanism, and said first transmission mechanism is different from said second transmission mechanism.

17. The method as claimed in claim 15, further comprising:
providing a power supply; and
activating said second receiver by said power supply when said first receiver does not receive said first synchronization signal.

18. The method as claimed in claim 15, wherein the step of determining whether said first receiver receives said first synchronization signal is to determine whether said first synchronization signal is received during a predetermined time period.

19. The method as claimed in claim 15, wherein said second receiver has a higher power consumption than said first receiver.

20. The method as claimed in claim 15, wherein said first synchronization signal is based on an infrared transmission mechanism, and said second synchronization signal is based on an FM transmission mechanism or a Bluetooth transmission mechanism.
